(19) United States
(12) Patent Application Publication
(10) Pub. No.: US 2010/0064920 A1
(43) Pub. Date: Mar. 18, 2010

(54) PRINT BOARD, METHOD FOR MANUFACTURING THE SAME, AND PRINTING METHOD USING THE SAME

(75) Inventors: Bo-Sung Kim, Seoul (KR); Kyu-Young Kim, Suwon-si (KR); Jung-Mok Bae, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/430,338

(22) Filed: Apr. 27, 2009

(30) Foreign Application Priority Data
Sep. 17, 2008 (KR) 10-2008-0091040

(51) Int. Cl. B41N 1/00

(52) U.S. Cl. 101/453

(57) ABSTRACT

The present invention relates to a print board that includes a substrate and a coating film that is formed on the substrate. The film includes an ink-philic portion and an ink-phobic portion disposed between adjacent ink-philic portions. The ink-phobic portion has more hydrophobicity than the ink-philic portion.

### CROSS-REFERENCE TO RELATED APPLICATION

This application claims priority from and the benefit of Korean Patent Application No. 10-2008-0091040, filed on Sep. 17, 2008, which is hereby incorporated by reference for all purposes as if fully set forth herein.

### BACKGROUND OF THE INVENTION

1. Field of the Invention

The present invention relates to a print board, a method for manufacturing the same, and a printing method using the same.

2. Discussion of the Background

In order to form a display device and an electronic device, a photolithography process is extensively used. However, the photolithography process increases initial investment cost because of the expensive equipment, such as exposure equipment, and it may require multiple costly masks, which reduce economic efficiency. Moreover, there is a limit in forming an ultrafine pattern through the photolithography process.

Accordingly, various pattern forming print methods, in which high-resolution printing technology is applied to a flat panel display to form various patterns on a substrate, are currently being used.

Among them, a reverse offset printing method has a drawback in that it has a high pattern resolution of not more than 15 μm, but reuse of the ink material on the print board may not be possible, it has a complicated ink washing process, and a roller used in the process should be manufactured to have a large scale. In addition, a gravure offset printing method has merit in that it uses ink efficiently, but it has a drawback in that the resolution is low as compared to the reverse offset printing method, the roller should be surface treated, and the roller should be manufactured to have a large scale. Further, an Ohno lift-up offset printing method, which does not use a roller process of a known offset printing method, may be used, but it is a developing technology. Thus, many compensations may be required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a print board in which resolution is high since a simple process may be used, use efficiency of an ink material may be improved, and deformation of a pattern shape may be minimized, a method for manufacturing the same, and a printing method using the same.

Additional features of the invention will be set forth in the description which follows, and in part will be apparent from the description, or may be learned by practice of the invention.

The present invention discloses a print board that includes a substrate and a coating film disposed on the substrate. The coating film includes an ink-philic portion and an ink-phobic portion disposed between adjacent ink-philic portions. The ink-phobic portion has more hydrophobicity than the ink-philic portion.

The present invention also discloses a method for manufacturing a print board. The method includes forming an ink-philic layer on a substrate, forming a resist pattern on the ink-philic layer, forming an ink-philic portion by etching the ink-philic layer using the resist pattern as a mask, forming an ink-phobic portion on a portion of the substrate that is exposed by etching the ink-philic layer, and removing the resist pattern.

The present invention also discloses a printing method using a print board. The method includes preparing the print board by forming a coating film including an ink-philic portion and an ink-phobic portion on a surface thereof, forming an ink layer on the ink-philic portion, drying the ink layer to form ink, transferring the ink to an ink transferring device, and transferring the ink from the ink transferring device to a substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A, FIG. 1B, FIG. 1C, FIG. 1D, and FIG. 1E are cross-sectional views that show a print board according to a first exemplary embodiment of the present invention and a manufacturing method thereof.

FIG. 2A, FIG. 2B, FIG. 2C, FIG. 2D, and FIG. 2E are cross-sectional views that show a print board according to a second exemplary embodiment of the present invention and a manufacturing method thereof.

FIG. 3A, FIG. 3B, FIG. 3C, FIG. 3D, and FIG. 3E are cross-sectional views that show a print board according to a third exemplary embodiment of the present invention and a manufacturing method thereof.

FIG. 4A, FIG. 4B, FIG. 4C, FIG. 4D, and FIG. 4E are cross-sectional views that show a printing method using a print board according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

### Exemplary Embodiment 1

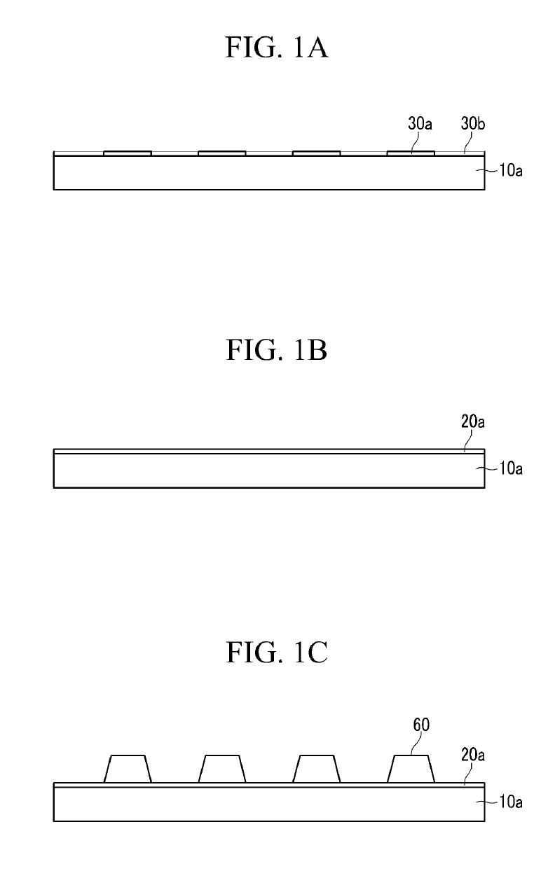

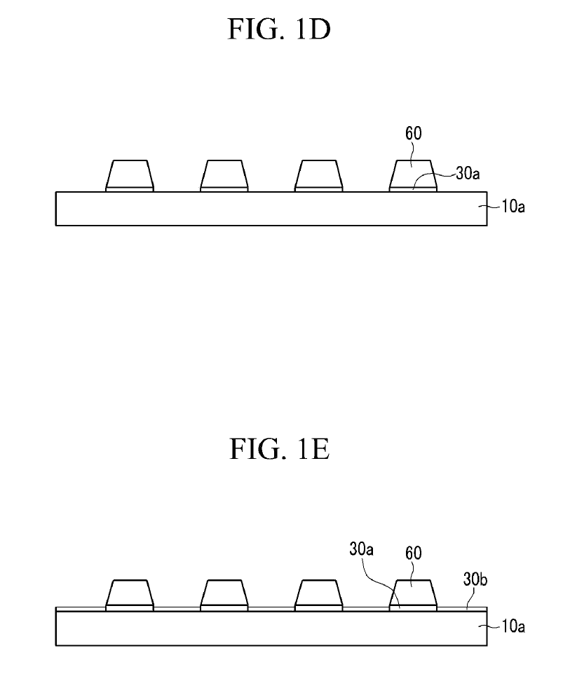

Hereinafter, a print board according to a first exemplary embodiment of the present invention and a manufacturing method thereof will be described with reference to FIG. 1A, FIG. 1B, FIG. 1C, FIG. 1D, and FIG. 1E.

Referring to FIG. 1A, the print board according to the first exemplary embodiment of the present invention includes a substrate 10a and a coating film formed on the substrate 10a. The substrate 10a is made of a glass. The coating film includes an ink-philic portion 30a and an ink-phobic portion 30b that is formed between adjacent ink-philic portions 30a. Here, the ink-philic portion 30a includes at least one selected from an aliphatic compound, an aromatic compound, and a hydrocarbon compound in which fluorine atoms or halogen atoms are partially substituted, and has a functional group that is bonded to the substrate 10a. The ink-phobic portion 30b includes at least one selected from an aliphatic compound and an aromatic compound in which fluorine atoms are entirely substituted and is in a saturated state, and has a functional group that is bonded to the substrate 10a.

The surface energy of the ink-philic portion 30a is higher than the surface energy of the ink-phobic portion 30b. This is because the ink-philic portion 30a has a less hydrophobic functional group in which fluorine atoms are partially substituted on the surface that is opposite to the surface bonded to the substrate 10a (i.e., the surface that will be bonded to ink), and the ink-phobic portion 30b has a more hydrophobic functional group in which fluorine atoms are entirely substituted on the surface thereof.

Next, referring to FIG. 1B, FIG. 1C, FIG. 1D, and FIG. 1E, a method for manufacturing the print board of FIG. 1A will be described.

First, as shown in FIG. 1B, the substrate 10a is prepared, and an ink-philic layer 20a is formed on the substrate 10a. Here, the ink-philic layer 20a includes at least one selected from an aliphatic compound, an aromatic compound, and a hydrocarbon compound in which fluorine atoms or halogen atoms are partially substituted, and has a functional group that is bonded to the substrate 10a. As described below, the ink-philic layer 20a may be formed by treating the surface of the substrate 10a by using a self assembly monolayer (SAM).

Next, a resist pattern 60 is formed on the ink-philic layer 20a. Here, the steps for forming the resist pattern 60 will be described in detail. After a resist layer (not shown) is coated on the ink-philic layer 20a, a photo-mask, which is capable of forming a pattern, is disposed on the resist layer, and the resist layer is exposed. Next, the resist layer is etched to form the resist pattern 60, as shown in FIG. 1C. As shown in FIG. 1D, by removing the exposed portion of the ink-philic layer 20a using the resist pattern 60 as a mask, the ink-philic portion 30a is formed under the resist pattern 60. Next, as shown in FIG. 1E, by forming the ink-phobic portion 30b on the portion of the substrate 10a from which the ink-philic layer 20a is removed, the print board according to the first exemplary embodiment of FIG. 1A is formed. Here, the ink-phobic portion 30b includes at least one selected from an aliphatic compound and an aromatic compound in which the fluorine atoms are entirely substituted and that has a functional group that is bonded to the substrate 10a.

The ink-philic portion 30a and ink-phobic portion 30b may be formed by treating the surface of the substrate 10a by using the SAM.

In detail, the SAM may be formed by dipping the SAM layer forming the ink-philic portion 30a or ink-phobic portion 30b on the surface of the substrate 10a or coating it by using a method such as spin coating, removing an unnecessary portion thereof, leaving the SAM layer, and washing the remaining SAM layer. If the SAM material is left, the SAM material forms a bond of itself, the SAM material is chemically bonded to form a single-layered thin film, and a plurality of thin film layers grow on the single layer by using physical bonding. Since the SAM material that is bonded to the surface of the substrate 10a through the single layer forms a chemical bond, it is very strongly bonded thereto. On the other hand, a plurality of layers that grow through the physical bonding on the single layer of the SAM form a relatively weak bond. Accordingly, if in next step, the surface of the recess portion is washed by using the solvent such as isopropyl alcohol, a plurality of layers that are connected thereto through the physical bonding are easily destroyed, thus it is easy to remove.

### Exemplary Embodiment 2

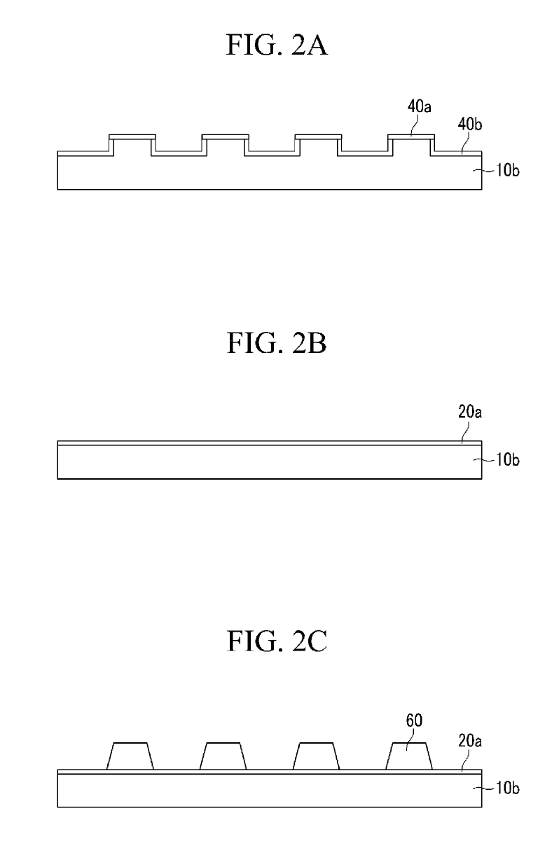

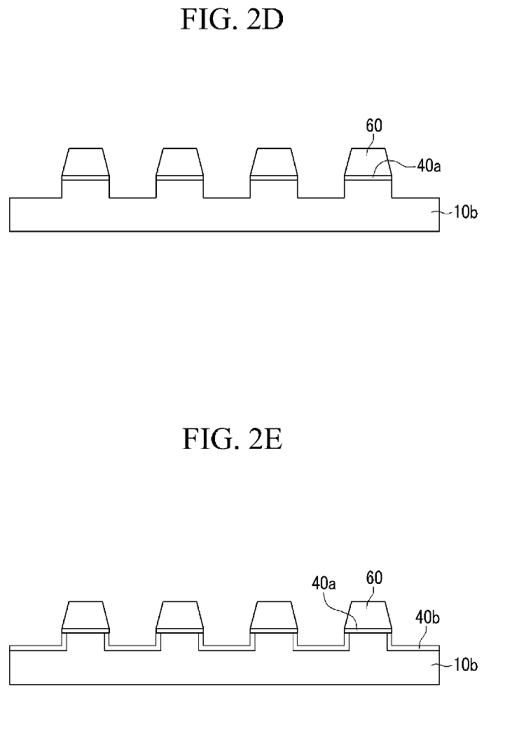

Referring to FIG. 2A, FIG. 2B, FIG. 2C, FIG. 2D, and FIG. 2E, a print board according to the second exemplary embodiment of the present invention and a manufacturing method thereof will be described.

The second exemplary embodiment will be described in portions where it differs from the first exemplary embodiment.

The print board according to the second exemplary embodiment of the present invention includes a substrate 10b that has a different shape from that of the first exemplary embodiment. Referring to FIG. 2A, the substrate 10b has a surface that includes a convex portion and a recess portion, an ink-philic portion 40a is formed on an upper surface of the convex portion, and an ink-phobic portion 40b is formed on the bottom surface and the side of the recess portion. Accordingly, the ink-philic portion 40a is protruded as compared to the ink-phobic portion 40b.

Next, referring to FIG. 2B, FIG. 2C, FIG. 2D, and FIG. 2E, a method for manufacturing the print board according to the second exemplary embodiment of the present invention will be described.

According to the manufacturing method of the second exemplary embodiment, when the ink-philic portion 40a is formed under the resist pattern 60, unlike the first exemplary embodiment, the substrate 10b is also etched using the resist pattern 60 as a mask, thereby forming the convex portion and the recess portion on the surface of the substrate 10b.

First, as shown in FIG. 2B, the substrate 10b is prepared, and an ink-philic layer 20a is formed on the substrate 10b. Here, the ink-philic layer 20a may include at least one selected from an aliphatic compound, an aromatic compound, and a hydrocarbon compound in which fluorine atoms or halogen atoms are partially substituted, and has a functional group that is bonded to the substrate 10b. The ink-philic layer 20a may be formed by treating the surface of the substrate 10a by using a SAM.

Next, the resist pattern 60 is formed on the ink-philic layer 20a. Here, the steps for forming the resist pattern 60 will be described in detail. After a resist layer (not shown) is coated on the ink-philic layer 20a, a photo-mask, which is capable of forming a pattern, is disposed on the resist layer, and the resist layer is exposed. Next, the resist layer is etched to form the resist pattern 60, as shown in FIG. 2C. As shown in FIG. 2D, by etching the exposed portion of the ink-philic layer 20a and a portion of the substrate 10b using the resist pattern 60 as a mask, the convex portion and the recess portion are formed in the substrate 10b, and the ink-philic portion 40a is formed between the lower part of the resist pattern 60 and the convex portion of the surface of the substrate 10b. Next, as shown in FIG. 2E, by forming the ink-phobic portion 40b on the bottom surface and the side of the recess portion, the print board according to the second exemplary embodiment of FIG. 2A is formed. Here, the ink-phobic portion 40b includes at least one selected from an aliphatic and an aromatic compound in which the fluorine atoms are entirely substituted and has a functional group that is bonded to the substrate 10b.

In the second exemplary embodiment, the ink-philic portion 40a and ink-phobic portion 40b may be formed by treating the surface of the substrate 10b by using the SAM.

Since the ink-philic portion 40a is disposed on the convex portion of the substrate 10b, in the printing process, when ink is formed on the ink-philic portion 40a, the selectivity of ink to the ink-philic portion 40a may be improved. Further, when the ink that is formed on the ink-philic portion 40a is transferred to the ink transferring means, the ink is capable of being in good contact with the ink transferring means, which may improve the precision of the pattern. Here, a stepped portion of the convex portion of the substrate 10b may be easily controlled, and finely controlled within a range of several tens of nanometers to several micrometers.

### Exemplary Embodiment 3

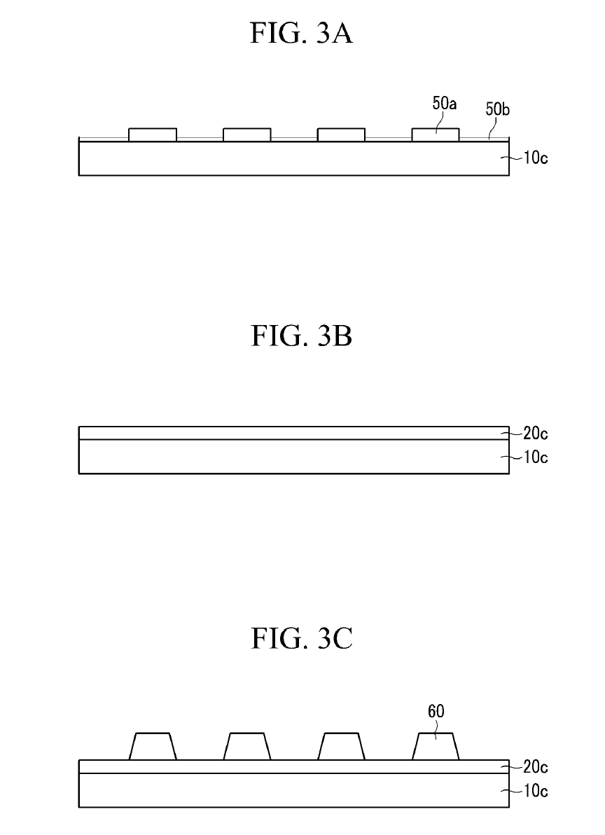

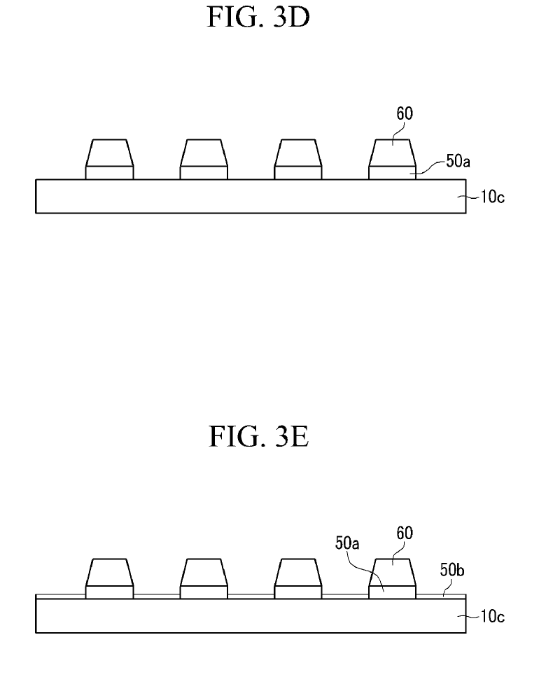

Referring to FIG. 3A, FIG. 3B, FIG. 3C, FIG. 3D, and FIG. 3E, a print board according to the third exemplary embodiment of the present invention and a manufacturing method thereof will be described.

The third exemplary embodiment will be described in portions where it differs from the first exemplary embodiment and the second exemplary embodiment.

The print board according to the third exemplary embodiment of the present invention includes an ink-philic portion 50a that has a different shape from that of the first exemplary embodiment. Referring to FIG. 3A, since the ink-philic portion 50a is thicker than an ink-phobic portion 50b, it is protruded from the ink-phobic portion 50b. Here, as the ink-philic portion 50a, a film that includes the hydrophobic organic material may be used.

Next, referring to FIG. 3B, FIG. 3C, FIG. 3D, and FIG. 3E, a method for manufacturing the print board according to the third exemplary embodiment of the present invention will be described.

The manufacturing method according to the third exemplary embodiment differs from that of the first exemplary embodiment in that when forming the ink-philic layer 20c on the substrate, the ink-philic layer 20c is thicker than the ink-phobic portion 50b that will be formed later.

First, as shown in FIG. 3B, the substrate 10c is prepared, and the ink-philic layer 20c is formed on the substrate 10c. Here, the ink-philic layer 20c includes at least one selected from an aliphatic compound, an aromatic compound, and a hydrocarbon compound in which fluorine atoms or halogen atoms are partially substituted, and has a functional group that is bonded to the substrate 10c. The ink-philic layer 20c may be formed by treating the surface of the substrate 10a by using a SAM.

Next, the resist pattern 60 is formed on the ink-philic layer 20c. Here, the steps for forming the resist pattern 60 will be described in detail. After a resist layer (not shown) is coated on the ink-philic layer 20c, which is formed on the substrate 10c in a greater thickness than that of the first exemplary embodiment, a photo-mask, which is capable of forming a pattern, is disposed on the resist layer, and the resist layer is exposed. Next, the resist layer is etched to form the resist pattern 60, as shown in FIG. 3C. As shown in FIG. 3D, by removing the exposed portion of the ink-philic layer 20c using the resist pattern 60 as a mask, the ink-philic portion 50a is formed under the resist pattern 60. Next, as shown in FIG. 3E, by forming the ink-phobic portion 50b on the portion of the substrate 10c from which the ink-philic portion 50a is removed, the print board according to the third exemplary embodiment of FIG. 3A is formed. Here, the ink-phobic portion 50b includes at least one selected from an aliphatic and an aromatic compound in which the fluorine atoms are entirely substituted and has a functional group that is bonded to the substrate 10c. Here, the ink-philic portion 50a is protruded as compared to the ink-phobic portion 50b, and the ink-philic portion 50a is thicker than the ink-phobic portion 50b.

In the third exemplary embodiment, the ink-philic portion 50a and the ink-phobic portion 50b may be formed by treating the surface of the substrate 10b by using the SAM.

Like the second exemplary embodiment, this exemplary embodiment forms a stepped portion so that the ink-philic portion 50a is protruded as compared to the ink-phobic portion 50b, but since this embodiment controls the stepped portion by controlling the thickness of the ink-philic layer 20c, rather than etching the substrate 10c, it may be easier to control the thickness. Here, the thickness of the ink-philic portion 50a may be easily controlled, and finely controlled within a range of several tens of nanometers to several micrometers.

### Exemplary Embodiment 4

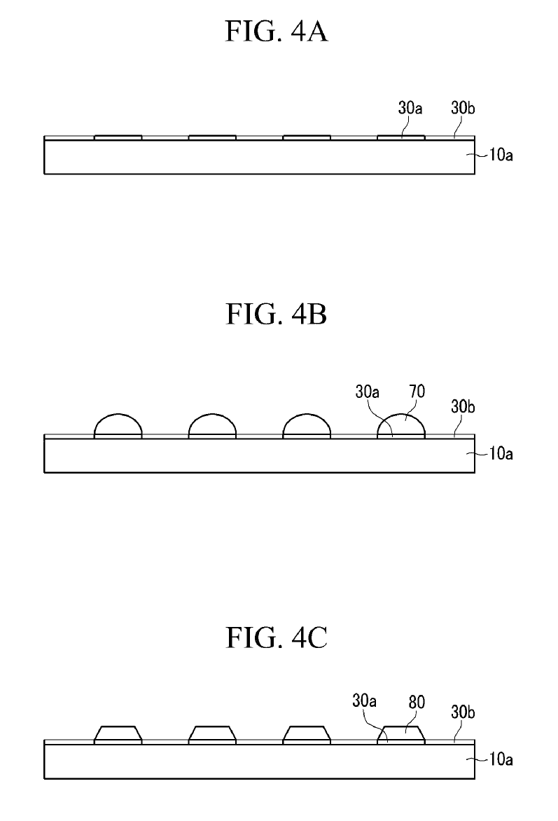

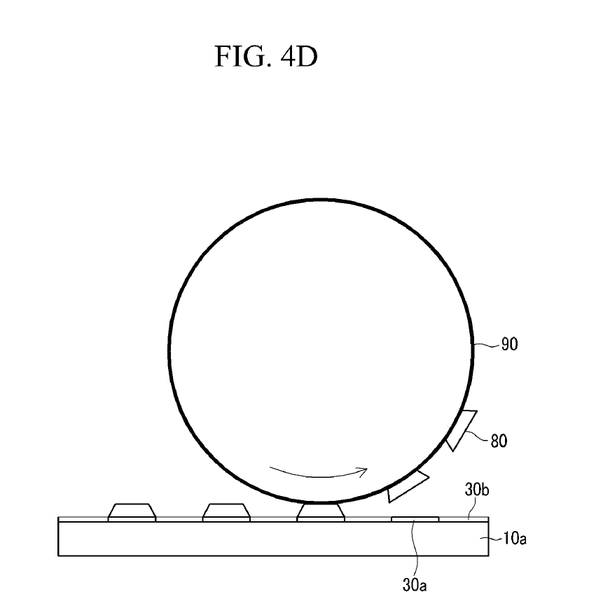

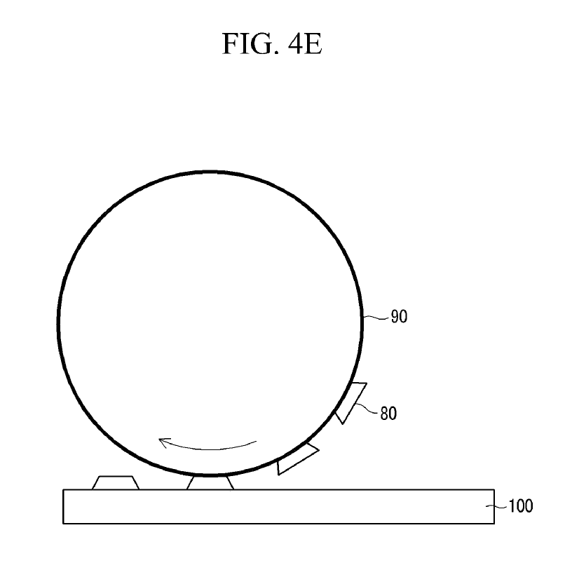

Referring to FIG. 4A, FIG. 4B, FIG. 4C, FIG. 4D, and FIG. 4E, a printing method using a print board according to an exemplary embodiment of the present invention will be described below.

FIG. 4A shows a print board that was manufactured according to the first exemplary embodiment of the present invention. As shown in FIG. 4B, an ink layer 70, which includes a binary solvent, is formed on the print board. The ink may be formed using, for example, Inkjet printing, slit coating, and contact printing. The ink layer 70 includes a binary solvent that includes a first solvent and a second solvent, which has a relatively lower boiling point than the first solvent. When the ink layer 70 is dried, the first component having the relatively low boiling point in the binary solvent is removed. The ink layer 70 is formed by contacting it to the upper surface of the ink-philic portion 30a having the less hydrophobic functional group on the surface thereof, and since the surface energy of the ink-phobic portion 30b is lower than the surface energy of the ink-philic portion 30a, the ink layer 70 may be disposed as described above. Next, the disposed ink layer 70 is naturally dried or is dried in drier and ink 80 is formed on the print board as shown in FIG. 4C. Next, as shown in FIG. 4D, the ink 80 that is formed on the print board is transferred to the ink transferring device 90. Here, the ink transferring device 90 may be a roller or may be plate-shaped, and a blanket that is made of silicon may be used. Here, since the surface energy of the ink transferring device 90 is higher than the surface energy of the ink-philic portion 30a, the ink 80 may be transferred from the surface of the ink-philic portion 30a to the ink transferring device 90. Finally, as shown in FIG. 4E, the ink 80 on the ink transferring device 90 is printed on a substrate 100 that is a print subject.

If the print board according to an exemplary embodiment of the present invention is applied to a printing process, by using a simple process, resolution is capable of being made high, use efficiency of an ink material is capable of being improved, and deformation of a pattern shape is capable of being minimized.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A print board, comprising:
a substrate; and
a coating film disposed on the substrate and comprising an ink-philic portion and an ink-phobic portion disposed between adjacent ink-philic portions,
wherein the ink-phobic portion has more hydrophobicity than the ink-philic portion.

2. The print board of claim 1, wherein
a surface energy of the ink-philic portion is higher than a surface energy of the ink-phobic portion.

3. The print board of claim 2, wherein
the ink-philic portion comprises at least one compound selected from an aliphatic compound, an aromatic compound, and a hydrocarbon compound, and fluorine atoms or halogen atoms are partially substituted in the at least one compound.

4. The print board of claim 2, wherein
the ink-phobic portion comprises at least one compound selected from an aliphatic compound and an aromatic compound, and fluorine atoms are entirely substituted in the at least one compound.

5. The print board of claim 1, wherein
each of the ink-philic portion and the ink-phobic portion further comprise a functional group that is bonded to the substrate.

6. The print board of claim 1, wherein
the ink-philic portion is protruded as compared to the ink-phobic portion.

7. The print board of claim 6, wherein
a surface of the substrate comprises a convex portion and a recess portion, the ink-philic portion being disposed on an upper surface of the convex portion, and the ink-phobic portion being disposed on a bottom surface of the recess portion.

8. The print board of claim 7, wherein
the ink-phobic portion is further disposed on a side surface of the recess portion.

9. The print board of claim 6, wherein
the ink-philic portion is thicker than the ink-phobic portion.

10. The print board of claim 9, wherein
the ink-philic portion comprises a hydrophobic organic material.

11. A method for manufacturing a print board, the method comprising:
forming an ink-philic layer on a substrate;
forming a resist pattern on the ink-philic layer;
forming an ink-philic portion by etching the ink-philic layer using the resist pattern as a mask;
forming an ink-phobic portion on a portion of the substrate that is exposed by etching the ink-philic layer; and
removing the resist pattern.

12. The method of claim 11, wherein
the ink-phobic portion has more hydrophobicity than the ink-philic portion.

13. The method of claim 12, wherein
the ink-philic portion comprises at least one compound selected from an aliphatic compound, an aromatic compound, and a hydrocarbon compound, and a fluorine atom or a halogen atom is partially substituted in the at least one compound, and
the ink-phobic portion comprises at least one compound selected from an aliphatic compound and an aromatic compound, and fluorine atoms are entirely substituted in the at least one compound.

14. The method of claim 13, wherein
the ink-philic portion and the ink-phobic portion are formed by forming a self assembly monolayer (SAM).

15. The method of claim 11, further comprising:
before forming the ink-phobic portion,
etching the portion of the substrate that is exposed by etching the ink-philic layer to form a recess portion in the substrate.

16. The method of claim 11, wherein
the ink-philic portion is thicker than the ink-phobic portion.

17. The method of claim 16, wherein
the ink-philic portion comprises a hydrophobic organic material.

18. A printing method using a print board, the method comprising:
preparing the print board by forming a coating film comprising an ink-philic portion and an ink-phobic portion on a surface of the print board;
forming an ink layer on the ink-philic portion;
drying the ink layer to form ink;
transferring the ink to an ink transferring device; and
transferring the ink from the ink transferring device to a substrate.

19. The method of claim 18, wherein
the ink layer comprises a binary solvent.

20. The method of claim 19, wherein
the binary solvent comprises a first solvent and a second solvent, the second solvent having a lower boiling point than that of the first solvent.

21. The method of claim 20, wherein,
drying the ink layer to form ink comprises removing the second solvent.

22. The method of claim 18, wherein
the ink transferring device is either a roller or a plate.

23. The method of claim 22, wherein
the ink transferring device comprises a blanket comprising silicon.

24. The method of claim 23, wherein
a surface energy of the blanket is higher than a surface energy of the ink-philic portion.

25. The method of claim 18, wherein
the ink-phobic portion has more hydrophobicity than the ink-philic portion.
